(19) United States
(12) Patent Application Publication
(10) Pub. No.: US 2019/0106999 A1
(43) Pub. Date: Apr. 11, 2019

(54) LABYRINTH SEAL FOR A TURBINE ENGINE OF AN AIRCRAFT

(71) Applicant: SAFRAN AIRCRAFT ENGINES, Paris (FR)

(72) Inventors: Clement JAROSSAY, Paris (FR); Guilhem Camille Francois VERRON, Arthez-de-Bearn (FR); Maurice Guy JUDET, Dammarie les Lys (FR); Clement Raphael LAROCHE, Saint Fargeau (FR); Guillaume Michel Maurice GILIBERTI, Issy les Moulineaux (FR)

(21) Appl. No.: 16/140,442

(22) Filed: Sep. 24, 2018

(30) Foreign Application Priority Data
Sep. 26, 2017 (FR) 1758918

(51) Int. Cl. F01D 11/00; F01D 11/02

(52) U.S. Cl. CPC F01D 11/001; F05D 2240/55; F01D 11/02

(57) ABSTRACT

Labyrinth seal for a turbine engine, in particular of an aircraft, including a rotor element rotating about an axis of rotation (A), and a stator element extending around the rotor element (14), the rotor element including a series of annular lip(s) extending radially outwards and surrounded by at least one abradable element carried by the stator element, each lip comprising an inner peripheral body portion, an outer peripheral body portion, an upstream annular face of impact of an air flow during operation and a downstream annular face, wherein at least one lip includes, on the inner peripheral body portion thereof and/or the outer peripheral body portion thereof, through-orifices for the passage of air extending between the upstream and downstream annular faces.

### TECHNICAL FIELD

The present invention relates to a labyrinth seal for a turbine engine, in particular of an aircraft.

### STATE OF THE ART

The state of the art comprises especially document DE-T5-11 2015 000 575.

It is known to equip a turbine engine with labyrinth seals which are dynamic seals whose sealing is provided by rotating lips. Such as is shown in FIG. 1, the lips 12 are carried by a rotor element 14 of the turbine engine 10, which rotates inside a stator element 16 and are surrounded by abradable elements 18 such as blocks or a coating of abradable material carried by this stator element 16.

The abradable elements 18 have the purpose of protecting the lips 12 from risks of wear by contact with the element 16 that surrounds them. The contacts with the abradable elements 18 can be avoided or on the contrary sought for example in order to optimise the radial clearances J around the lips. The types of abradable elements 18 and lips 12 can be adapted in consequence.

This technology can be used to ensure a seal at the tips of the blades of a rotor wheel, these blades carrying annular lips, possibly sectorised, which are surrounded by abradable elements carried by a stator casing (see especially FR-A1-3 001 759). It can also be used to ensure a seal between a portion of shaft or trunnion and a stator of the turbine engine. The number and the dimensions of the lips are especially according to the radial space available between the elements to be sealed.

In operation, such as is shown in FIGS. 2 and 3, the lips 12 have the function of disturbing the flow of gas that attempts to flow between the elements 14, 16 from upstream to downstream, in other words from left to right in the drawings. This creates turbulences in the flow of gas which generate pressure losses and as such improve the sealing of the seal.

On each lip 12 to be crossed, the flow of air is disturbed a first time when it impacts the body of the lip (arrow F1). The flow of air crosses the radial clearance J at the top of the lip 12 then is disturbed a second time (arrow F2) following the sudden increase in the passage section after crossing through the lip. The higher the number of lips 12, the more turbulence is generated in the flow of air, and the more the sealing of the seal is improved.

The present invention proposes an improvement to this technology in order to improve the sealing of the seal simply, effectively and economically.

### SUMMARY OF THE INVENTION

The invention proposes a labyrinth seal for a turbine engine, in particular of an aircraft, comprising a rotor element rotating about an axis of rotation, and a stator element extending around the rotor element, the rotor element comprising a series of annular lip(s) extending radially outwards and surrounded by at least one abradable element carried by the stator element, each lip comprising an inner peripheral body portion, an outer peripheral body portion, an upstream annular face of impact of an air flow during operation and a downstream annular face, characterised in that at least one lip comprises, on the inner peripheral body portion thereof and/or the outer peripheral body portion thereof, through-orifices for the passage of air extending between said upstream and downstream annular faces.

The invention consists of piercing one or several lips with one or several orifices. The flow of air passing through these orifices can thus create a dynamic overpressure just behind the top of each lip, due to the stoppage point thus generated at this location of the flow. This overpressure will then decrease the flow of air passing through the global seal. The sealing of the global seal will as such be improved. In addition, the flow of air that passes through the orifice or orifices participates in accelerating the flow of air and/or in increasing the turbulences in the inter-lip spaces. The sealing of the global seal will also be improved since the flow of air in the inter-lip spaces generates turbulences that oppose the direction of flow of the gases.

On each lip pierced with orifice(s), the flow of air is disturbed a first time when it impacts the body of the lip. The flow of air is disturbed a second time when it crosses the radial clearance at the top of the lip. Finally, the flow of air is either compressed at the outlet of the lip or accelerated, as mentioned hereinabove, which increases the turbulences and pressure losses and makes it possible to improve the performance of the seal.

The invention thus makes it possible, for the same level of sealing, to reduce the size and the weight of the seal, for example by suppressing one of the lips. It also makes it possible, for the same number of lips, to significantly increase the sealing level of the seal. It furthermore makes it possible, for the same level of sealing, to keep the number of lips but to increase the radial clearances with the element that surrounds it in order on the one hand to simplify their integration by reducing the mounting constraints, and on the other hand by facilitating the control of the clearances.

The seal according to the invention can comprise one or more of the following characteristics, taken individually from one another or in combination with one another:
the orifices are oriented from upstream to downstream radially outwards,
the orifices are located between 10 and 90% of the height of the lip,
the orifices are located in said top,
the orifices are oriented from upstream to downstream radially inwards,
the orifices are located in said body,
the orifices are inclined with respect to an axis parallel to said axis of rotation; the inclination angle is between −70° and 70°,
said at least one of said lips comprises at least one annular row of through-orifices, regularly distributed about said axis of rotation,
said orifices have a diameter comprised between 0.2 mm and 1 mm.
said at least one of said lips comprises a number of orifices between 5 and 20.

This invention further relates to a turbine engine, characterised in that it comprises at least one seal such as described hereinabove.

### DESCRIPTION OF THE FIGURES

The invention shall be better understood and other details, characteristics and advantages of the invention shall appear more clearly upon reading the following description given by way of a non-limiting example and in reference to the appended drawings wherein:

FIG. 1 is an axial cross-section, schematic half-view of a turbine engine labyrinth seal, according to prior art;

FIGS. 2 and 3 are schematic views on a larger scale of details of FIG. 1;

FIG. 4 is an axial cross-section, schematic half-view of a turbine engine labyrinth seal, according to a first embodiment of the invention;

FIG. 5 is a schematic view on a larger scale of a detail of FIG. 4;

FIG. 6 is an axial cross-section, schematic half-view of a turbine engine labyrinth seal, according to an alternative embodiment of the invention;

FIG. 7 is a schematic view on a larger scale of a detail of FIG. 6.

### DETAILED DESCRIPTION

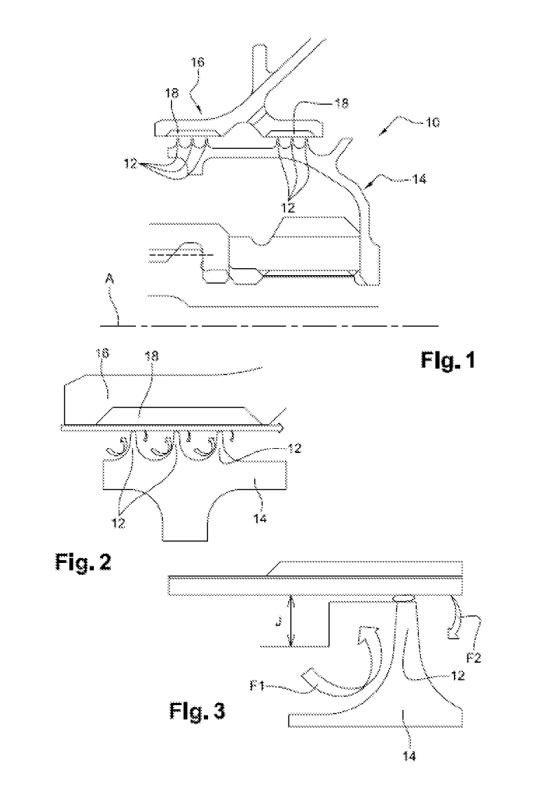

FIGS. 1 to 3 have been described hereinabove.

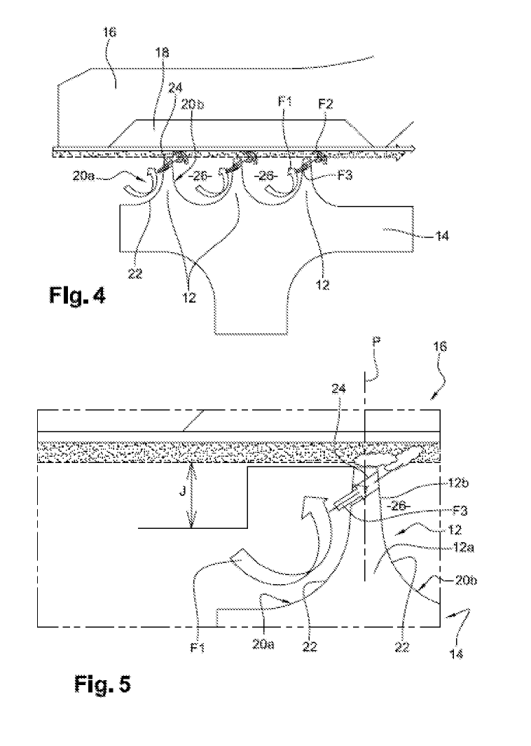

FIGS. 4 and 5 show a first embodiment of the invention.

As in prior art, each lip 12 comprises an annular body 12a and a free annular top 12b, generally pointed, in other words, of which the width or axial dimension is less than that of the body 12a.

In the example shown, the lip 12 has a symmetry with respect to a median plane P substantially perpendicular to the axis of rotation of the rotor element 14.

Each lip 12 comprises an upstream annular face 20a and a downstream annular face 20b, the flow of gas flowing from upstream to downstream through the seal and more generally in the turbine engine, and from left to right in the drawings.

The lips 12 are separated from one another by annular spaces 26. The spaces 26 have a section with a general U-shape in the example shown.

The body 12a of each lip 12 comprises, in observation of the side of the upstream face 20a, an annular cavity 22 with a section with a concave rounded shape. Due to the symmetry of the body, the latter further comprises, in observation of the side of the downstream face 20b, another annular cavity with a section with a concave rounded shape similar to the annular cavity 22.

In the embodiment shown, the top 12b of at least one of the lips, and preferably of all of the lips, comprises an annular row of through-orifices 24 which open, at the upstream ends thereof, onto the upstream face 20a, and at the downstream ends thereof, onto the downstream face 20b.

The orifices 24 extend here from upstream to downstream radially outwards. The flow of air passing through these orifices 24 has the function of generating an overpressure or compression of the flow of air crossing the lip during operation.

On each lip 12 to be crossed, the top of which comprises orifices 24, the flow of air is disturbed a first time when it impacts the body 12a of the lip (arrow F1). The flow of air is diverted and guided by the cavity 22 and a portion flows through the orifices 24 and a portion flows above the top of the lip (arrow F2). This portion of the flow of air that crosses the radial clearance at the top of the lip is compressed and disturbed by the flow of air exiting from the orifices 24 (arrow F3). The turbulences in the flow of gas, after passing a lip, are therefore amplified with respect to prior art, which makes it possible to improve the performance of the seal.

The number of orifices 24 per lip 12 is for example between 5 and 20, and their diameter is for example comprised between 0.2 mm and 1 mm.

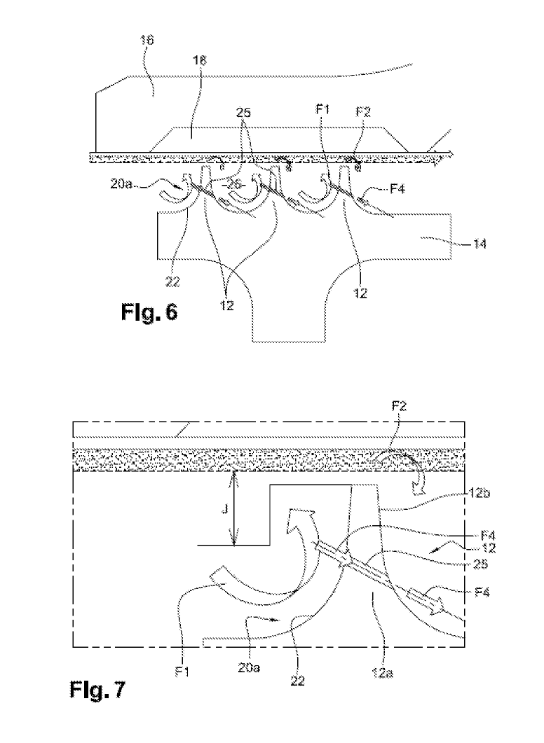

FIGS. 6 and 7 show an alternative embodiment of the invention.

In this variant, the body 12a of at least one of the lips, and preferably of all of the lips, comprises an annular row of through-orifices 25 that open, at the upstream ends thereof, onto the upstream face 20a, and at the downstream ends thereof, onto the downstream face 20b.

The orifices 25 extend here from upstream to downstream radially inwards. The flow of air passing through these orifices has the function of accelerating the flow of air entering the inter-lip space 26.

At the level of each lip 12 to be crossed, the top of which comprises orifices 25, the flow of air is disturbed a first time when it impacts the body 12a of the lip (arrow F1). The flow of air is diverted and guided by the cavity 22 and a portion flows through the orifices 25 and a portion flows above the top of the lip. This portion of the flow of air that crosses the radial clearance at the top of the lip and enters the inter-lip space 26 (arrow F2) is disturbed by the flow of air exiting from the orifices 25 (arrow F4). The turbulences in the flow of gas, after passing a lip, are therefore amplified with respect to prior art, which makes it possible to improve the performance of the seal.

The number of orifices 25 per lip 12 is for example comprised between 0 and 20, and their diameter is for example comprised between 0.2 mm and 1 mm.

The orifices are located between 10 and 90% of the height of the lip. Their angle with respect to an axis parallel to the axis of rotation, varies between −70° and 70°.

1. A labyrinth seal for a turbine engine, comprising a rotor element rotating about an axis of rotation, and a stator element extending around the rotor element, the rotor element comprising a series of annular lip(s) extending radially outwards and surrounded by at least one abradable element carried by the stator element, each lip comprising an inner peripheral body portion, an outer peripheral body portion, an upstream annular face of impact of an air flow during operation and a downstream annular face, wherein at least one lip comprises, on its inner peripheral body portion and/or its outer peripheral body portion, through-orifices for the passage of air extending between said upstream and downstream annular faces.

2. The labyrinth seal according to the claim 1, wherein the orifices are oriented from upstream to downstream radially outwards.

3. The labyrinth seal according to claim 1, wherein the orifices are oriented from upstream to downstream radially inwards.

4. The labyrinth seal according to claim 1, wherein the orifices are located between 10 and 90% of the height of the lip.

5. The labyrinth seal according to claim 1, wherein the orifices are inclined with respect to an axis parallel to said axis of rotation, the inclination angle being between −70° and 70°.

6. The labyrinth seal according to claim 1, wherein said at least one of said lips comprises at least one annular row of through-orifices, regularly distributed about said axis of rotation.

7. The labyrinth seal according to the claim 6, wherein said orifices have a diameter comprised between 0.2 mm and 1 mm.

8. The labyrinth seal according to claim 1, wherein said at least one of said lips comprises a number of orifices between 5 and 20.

9. A turbine engine, which comprises at least one labyrinth seal according to claim 1.
